(19) United States
(12) Patent Application Publication
(10) Pub. No.: US 2008/0098772 A1
(43) Pub. Date: May 1, 2008

(54) Method for fabricating an optical fiber assembly having at least one integral optical fiber device

(76) Inventors: Victor Il'ich Kopp, Flushing, NY (US); Victor Tchourikov, West Patterson, NJ (US); Jonathan Singer, New Hope, PA (US); Daniel Neugroschl, Suffern, NY (US)

Correspondence Address: EDWARD ETKIN, ESQ., Law Office of Edward Etkin, PC, 228 West End Avenue, Suite A, Brooklyn, NY, 11235, US

(21) Appl. No.: 11/544,416

(22) Filed: Oct. 6, 2006

(51) Int. Cl. G02B 6/255; B29D 11/00

(52) U.S. Cl. 65/406; 264/1.25; 264/1.28

(57) ABSTRACT

The present invention provides process for fabricating an optical fiber assembly that includes two or more integral optical fiber elements having different interface characteristics, where at least one of the elements is a fiber optic device (fiber grating, in-fiber polarizer, coupler, mode filter, etc.), and where the length, and thus the cost, of each fiber optic device is advantageously optimized. The inventive process utilizes a two-stage approach, where at a first process stage, one or more optical fibers are spliced to one or more predetermined optical fiber device preforms (usable to fabricate one or more optical fiber devices), and where at a second process stage, one or more preform processing techniques (such as one or more of: drawing, twisting, etching, wrapping, etc.), are applied to the one or more preforms, to fabricate one or more corresponding optical fiber devices that are already integral with the optical fibers on one or both ends, thus forming the desirable optical fiber assembly. In another embodiment of the inventive process, multiple optical fiber assemblies can be readily and easily fabricated in a continuous process, by fabricating a single optical fiber assembly composed of multiple integral sequential desired optical fiber assemblies, and then separating the desired individual optical fiber assemblies from one another.

### CROSS REFERENCE TO RELATED APPLICATIONS

The present patent application claims priority from the commonly assigned co-pending U.S. patent application Ser. No. 11/015,565 entitled “Optical Fiber Coupler with Low Loss and High Coupling Coefficient and Method of Fabrication Thereof”, filed Dec. 18, 2004, which in turn claims priority from the commonly assigned provisional patent application Ser. No. 60/530,517 entitled “Optical Fiber Coupler with Low Loss and High Coupling Coefficient and Method of Fabrication Thereof” filed Dec. 18, 2003.

### FIELD OF THE INVENTION

The present invention relates generally to fabrication of optical fiber assemblies from multiple optical fiber elements, and more particularly to processes for fabrication of optical fiber assemblies having two or more optical fiber elements with different interface characteristics, where at least one of the elements is a fiber optic device, and where the length, and thus the cost, of the device is advantageously optimized.

### BACKGROUND OF THE INVENTION

The continuing proliferation of optical fiber systems and networks continues to generate a growing demand for optical fiber devices, such as fiber lasers, fiber gratings, in-fiber polarizers, mode filters, etc., that are essential for various key optical fiber network and system components.

Typically, various optical fiber devices are fabricated utilizing different types of commercially available optical fibers that are subjected to a series of complex precisely controlled procedures to produce a resulting device having desired properties. However, all previously known approaches to fabricating fiber devices, suffer from a number of serious disadvantages.

First, even though typical communication optical fibers are relatively inexpensive, most fiber optic device fabrication procedures are costly and complex. The required precision of fabrication, coupled with complexity of the necessary fabrication steps, in some cases may result in a significant amount of unusable products which must be discarded. For example, fabrication of conventional fiber Bragg gratings involves producing a UV radiation mask based on the desired grating properties, and then carefully subjecting a length of the UV-sensitive fiber to UV radiation through the UV mask to impose very precise refractive index modulation in the UV-sensitive fiber corresponding to the desired Bragg grating specifications. Procedures of similar complexity are also necessary for fabrication of other types of fiber devices from commercially available optical fibers.

In addition, most fabrication processes can only be configured to produce fiber devices having very specific strictly predefined properties. In such cases, any proposed changes in desired device specifications, require reconfiguration, and/or replacement of all or part of the fabrication process. For example, a fabrication process that uses the above-described UV mask can only produce fiber Bragg gratings with very specific characteristics corresponding to the specific UV mask configuration (and/or for example, corresponding to the properties of the UV radiations source). Any desired changes in characteristics of the fabricated Bragg gratings, would at the very least require design and production of a new UV mask. Thus, in many cases, the previously known fiber component fabrication processes are inflexible and likely do not allow selective changes in product characteristics.

Finally, the procedures, materials, and/or techniques involved in many previously known fiber device fabrication processes, often significantly restrict or limit the operational capabilities of the fiber devices produced therefrom. For example, because UV-sensitive optical fibers are used to fabricate most conventional Bragg gratings, such gratings may degrade in a situation where they may be exposed to UV light, or to high temperatures. The operational profiles and environmental vulnerabilities of other types conventional fiber devices are likewise very dependent on the nature of the fabrication processes utilized for their production.

However, all of the above disadvantages have been addressed by development and introduction of number of novel fiber devices, based on chiral optical fibers, as well as novel methods for fabrication thereof. The various inventive chiral fiber products are described in greater detail in the following commonly assigned U.S. patents, all of which are hereby incorporated by reference herein in their entirety: U.S. Pat. No. 6,839,486 for “Chiral Fiber Grating”; U.S. Pat. No. 6,721,469 for “Chiral In-Fiber Adjustable Polarizer Apparatus and Method”; U.S. Pat. No. 6,792,169 for “Chiral Fiber Sensor Apparatus and Method”; U.S. Pat. No. 7,009,679 for “Chiral Broadband Tuning Apparatus and Method”; U.S. Pat. No. 6,741,631 for “Customizable Apodized Chiral Fiber Grating Apparatus and Method”; U.S. Pat. No. 6,925,230 for “Long Period Chiral Fiber Grating Apparatus”; and U.S. Pat. No. 7,095,911 for “Chiral In-Fiber Polarizer Apparatus and Method”.

The various chiral fiber devices described in the above-incorporated patents are far more versatile than similar products that are fabricated from conventional optical fibers, because chiral fiber devices are not limited by the constraints imposed on conventional fiber devices as a result of the specific properties of the optical fibers from which the products were made, and/or as a result of their fabrication processes. Additional numerous advantages of chiral optical fiber devices over conventional optical fiber devices, are described in greater detail in the various above-incorporated patents.

In addition, a number of advantageous novel chiral optical fiber device fabrication techniques are described in greater detail in the following commonly assigned co-pending U.S. patent applications entitled “Apparatus and Method for Manufacturing Periodic Grating Optical Fibers”, Apparatus and Method of Manufacturing Chiral Fiber Bragg Gratings”, “Apparatus and Method for Fabricating Chiral Fiber Gratings”, all of which are hereby incorporated by reference herein in their entirety.

In essence, the primary embodiments of the inventive fabrication techniques described in the above-incorporated patent applications, are based on the principle of applying one or more preform processing techniques to various specially prepared custom fiber device preforms, to obtain a final chiral fiber device with desirable properties. Application of such a technique (or techniques) imposes one or more predefined refractive index modulation profiles on at least a portion of a preform, and/or otherwise changes the preform to correspond to the intended properties of the desired chiral fiber device.

Examples of the above-mentioned preform processing techniques include, but are not limited to one or more of the following, individually, and/or in any combination thereof: drawing the preform, twisting the preform about its longitudinal axis, etching the outer surface of the preform, wrapping the preform with one or more other preform elements. In addition, any other preform processing technique that changes one or more preforms into a desirable chiral fiber device, may be utilized as a matter of design choice without departing from the spirit of the invention.

Thus, all chiral fiber devices described in the above-incorporated patents can be advantageously fabricated from custom preforms (which, unlike preforms used to fabricate conventional fibers, are generally sized similarly to conventional fibers) by selective application of the above-described processing techniques thereto. As a result, because virtually all of the above-incorporated inventive fabrication approaches are very flexible and readily configurable (for example, by controlling the type, quantity, duration, and other parameters of the preform processing techniques), the specifications of the fabricated chiral fiber devices may be adjusted, changed as needed, or otherwise customized with minimal effort and expense (and certainly without having to redesign, or replace components in, the fabrication systems.

However, implementing chiral fiber devices in production optical fiber systems and/or networks is a challenging task, largely because chiral optical fiber devices typically have different interface characteristics from other optical fibers (such as conventional optical fibers), to which they must be connected.

Possible differences in interface characteristics, may include, but are not limited to, one or more of the following (individually or in combination with one another), different diameter (certain types of chiral fiber devices may have much smaller diameters than a typical optical fiber in commercial use), different cross-sectional geometry (for example, if the chiral fiber device is formed from multiple twisted smaller fiber elements, if its cross-section is not circular, if it is composed of a different material, etc.), and so on.

In addition, because of their small diameter and/or multi-element structure, chiral optical fiber products are frequently significantly more fragile than conventional fibers. Both of these issues are a concern both with respect to initial fabrication of chiral fiber devices (e.g., due to the difficulties in handling the devices, and due to their relative fragility), and more importantly for actual practical use in fabrication of subsystems and devices for optical fiber networks and systems.

One advantageous technique that at least partially addressed the above obstacles, involved construction of an optical fiber assembly composed of one or more desired chiral fiber devices spliced at one end (or at both ends) to a length of a conventional optical fiber. Such an assembly is not only easy to handle, but is also nearly as resilient as optical fiber devices based on conventional optical fibers, while retaining all of the advantages of chiral fiber devices.

In cases where the chiral fiber device is of a different diameter that a conventional fiber to which it must be spliced, various tapering techniques can be used to substantially match fiber sizes at the desired splice point area prior to splicing. In addition, the interfacing challenges were partially addressed by the solutions proposed in the commonly assigned co-pending U.S. patent application entitled “Optical Fiber Coupler with Low Loss and High Coupling Coefficient and Method of Fabrication Thereof”, from which the present application claims priority.

Specifically, this application was directed to addressing at least two of common obstacles encountered in interfacing optical waveguide devices, including chiral optical fiber devices, with conventional low index contrast optical fibers: (1) the difference between the diameters of the optical waveguide device and the conventional fiber (especially with respect to the differences in core sizes), and (2) the difference between the numerical apertures of the optical waveguide device and the conventional fiber. Failure to properly address these obstacles results in increased insertion losses and a decreased coupling coefficient at each interface. Accordingly the above-incorporated application advantageously provided various embodiments of a novel optical fiber coupler capable of providing a low loss, high coupling coefficient interface between conventional optical fibers and optical waveguide devices (i.e., chiral fiber devices), and further disclosed a number of embodiments of methods of fabrication thereof.

Splicing of the chiral fiber device(s), and one or more conventional fibers, can be done using a variety of well know splicing techniques, ranging from conventional splicing approaches, to more advanced splicing solutions, for example, such as those proposed in the following U.S. patents: U.S. Pat. Nos. 6,275,627 and 6,321,006, both entitled “Optical Fiber Having an Expanded Mode Field Diameter and Method of Expanding the Mode Field Diameter of an Optical Fiber” to Wu, U.S. Pat. No. 6,789,960, entitled “Method of Connecting Optical Fibers, an Optical Fiber Therefor, and an Optical Fiber Span Therefrom” to Bickham et al., and U.S. Pat. No. 6,939,060, entitled “Method and Apparatus for Heating Fusion Spliced Portion of Optical Fibers and Optical Fiber Array” to Tamura et al.

Due to the requirements of splicing techniques, and the necessity of handling and working with chiral fiber devices during fabrication of the desired optical fiber assemblies, the chiral fiber devices had to be of significantly greater lengths than were necessary for their utilization. These lengths were much greater than the lengths typically required by the chiral fiber devices, resulting in more expensive and/or unwieldy assemblies, that were even unacceptable for certain applications. Furthermore, due to their relative fragility, chiral fiber devices were more likely to be inadvertently damaged during the splicing processes than conventional fiber-based components.

In addition, while, the “Optical Fiber Coupler . . . ” application provided solutions for addressing certain types of interfacing issues, it did not address a number of other important challenges in interfacing chiral fiber devices with other (e.g., conventional) optical fibers, especially in situations where the diameters of all fibers involved were equal, but other interface differences were present. Furthermore, optical fiber assemblies needed to be fabricated individually, and while the techniques used were less expensive than fabrication of above-described conventional fiber-based devices, a certain amount of complexity was still present.

It would thus be desirable to provide a method for fabricating optical fiber assemblies having two or more optical fiber elements with different interface characteristics, where at least one of the elements is a fiber optic device, and where the length, and thus the cost, of the device is advantageously optimized. It would also be desirable to provide a method for fabricating multiple optical fiber assemblies, each having the same or different characteristics in a continuous fabrication process, while minimizing the cost of, and optimizing the length of, each such fabricated optical fiber assembly.

### BRIEF DESCRIPTION OF THE DRAWINGS

In the drawings, wherein like reference characters denote elements throughout the several views:

FIG. 1A is a schematic diagram of a side view of a first exemplary embodiment of an optical fiber assembly fabricated in accordance with the novel method of the present invention, having at least one optical fiber device integral with at least one optical fiber element;

FIG. 1B is a schematic diagram of a side view of an exemplary embodiment of a fiber device region of the inventive optical fiber assembly of FIG. 1A, in which the fiber device region includes a single fiber device;

FIG. 1C is a schematic diagram of a side view of an alternate exemplary embodiment of a fiber device region of the inventive optical fiber assembly of FIG. 1A, in which the fiber device region includes two or more fiber devices;

FIG. 1D is a schematic diagram of a side view of a second exemplary embodiment of an optical fiber assembly fabricated in accordance with the novel method of the present invention, having plural optical fiber elements and plural optical fiber devices integral therewith;

FIG. 1E is a schematic diagram of a side view of an alternate second exemplary embodiment of the optical fiber assembly of FIG. 1D, which has been split into two parts to produce two individual optical fiber assemblies;

FIG. 2 is a process flow diagram of a first embodiment of a novel multi-element optical fiber assembly fabrication process of the present invention that may be utilized to produce optical fiber assemblies and the elements thereof, of FIGS. 1A to 1E;

FIGS. 3A and 3B are schematic diagrams of a side view of first stage of an exemplary embodiment of a spliced intermediate fiber assembly produced during a first stage of the inventive fabrication process of FIG. 2;

FIG. 4 is an exemplary diagram illustrating various optical fiber device preform processing techniques that may be utilized individually and/or jointly in conjunction with the novel process of FIG. 2 to produce at least one optical fiber device for the optical fiber assemblies of FIGS. 1A to 1E, and the elements thereof; and

FIG. 5 (Example) is a process flow and schematic diagram illustrating various previously used techniques for fabricating optical fiber assemblies that consist of a conventional optical fiber and a separately fabricated chiral fiber device.

### SUMMARY OF THE INVENTION

The purpose of the present invention is to provide a novel process for fabricating an optical fiber assembly having two or more optical fiber elements with different interface characteristics, where at least one of the elements is a fiber optic device (fiber grating, in-fiber polarizer, coupler, mode filter, etc.), and where the length, and thus the cost, of the device is advantageously optimized.

In summary, the novel process of the present invention advantageously solves all of the challenges posed by previously used optical fiber assembly fabrication techniques utilizing the following two-stage approach:
(1) at a first process stage, splicing one or more optical fibers to one or more predetermined optical fiber device preforms usable to fabricate one or more optical fiber devices, and,
(2) at a second process stage, applying one or more preform processing techniques (such as one or more of: drawing, twisting, etching, wrapping, etc.), to the one or more preforms, to fabricate one or more corresponding optical fiber devices that are already integral with the optical fibers on one or both ends, thus forming the desirable optical fiber assembly.

In stark contrast to the previously used approach of splicing finished fibers and finished optical fiber devices, the novel process solves the interfacing issues between elements of the assembly, that have different interface characteristics, by selecting preform(s) (for intended devices), matched in interface characteristics to the one or more other optical fiber elements of the desired optical fiber assembly. Because the subsequent processing is only applied to sections of the preform(s) that are not immediately proximal to the splice point(s) with the other optical fiber element(s) of the assembly, differences in size and/or structure between the connected optical fiber and the fabricated optical fiber device(s) (for example, generated by drawing, twisting, etching, etc.), are only present in the processed region of the preform. In one embodiment of the present invention, the distance between the processed region of the preform(s) and the splice point(s), is optimized by balancing the strength of the splice point against minimization of the length of the region of the optical fiber device that is between the processed region and the splice point.

Accordingly, by selecting and splicing one or more optical fibers with one or more preforms (essentially forming a “pre-assembly”), and then selectively applying one or more preform processing techniques to the preform(s), an optical fiber assembly having virtually any desired properties may be readily fabricated. Thus, for example, by utilizing multiple preforms and predetermined preform processing techniques, it is possible to fabricate an optical fiber assembly having the functionality of multiple optical fiber devices.

In another embodiment of the process of the present invention, multiple optical fiber assemblies can be readily and easily fabricated in a continuous process, by forming a single elongated pre-assembly from multiple optical fibers and preforms in a desired sequential order, applying one or more preform processing techniques to each preform to produce multiple sequential optical fiber assemblies, and then separating the desired individual optical fiber assemblies from one another.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF THE PREFERRED EMBODIMENTS

The present invention is directed to a novel process for fabricating an optical fiber assembly that includes two or more integral optical fiber elements having different interface characteristics, where at least one of the elements is a fiber optic device (fiber grating, in-fiber polarizer, coupler, mode filter, etc.), and where the length, and thus the cost, of each fiber optic device is advantageously optimized.

At the outset, it should be noted that the descriptions of several embodiments of the present invention below, refer to conventional optical fibers, to preforms suitable for fabrication of chiral fiber devices therefrom, and to chiral fiber devices by way of example only. While the inventive process is especially useful for fabricating optical fiber assemblies that include one or more chiral fiber devices, the features of the various embodiments of the inventive process can be readily applied to fabrication of optical fiber assemblies from any type and/or combination of optical fibers and preforms that can be transformed into desirable optical fiber devices, as a matter of design choice and without departing from the spirit of the present invention.

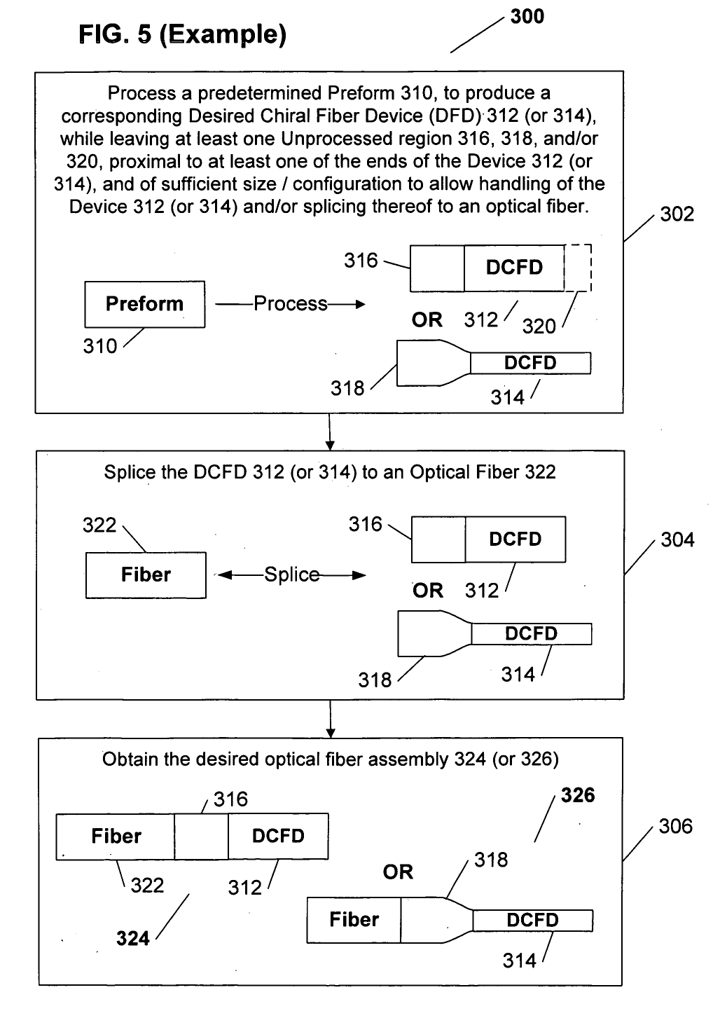

Before discussing the inventive process in greater detail, to better illustrate the advantageous novel features of the inventive process, it is helpful to briefly review an exemplary previously utilized process for fabricating optical fiber assemblies that included at least one chiral fiber device. Referring now to FIG. 5 (Example), an exemplary previously utilized fabrication process 300, for fabricating a desired optical fiber assembly 324 (or 326) is shown. At an initial step 302, a predetermined chiral preform 310 was processed, utilizing one or more preform processing techniques (e.g., drawing, twisting, etching, wrapping, etc.), while leaving at least a portion unprocessed (or partially processed), to:
(1) produce a desired chiral fiber device (hereinafter “DCFD”) 312 (e.g., a fiber grating, in-fiber polarizer, coupler, mode filter, etc.), that included an unprocessed region 316 at one end, of sufficient size to allow splicing of the DCFD 312 (and handling thereof), and that optionally included a second unprocessed region 320 at its other end, for splicing to a second conventional fiber;
   or, when the DCFD was to be of a smaller diameter than a conventional optical fiber, and the preform 310 processing included drawing to reduce diameter of the DCFD,
(2) produce a DCFD 314, that included a partially processed region 318, sized, at one end, to correspond to a conventional optical fiber, and tapered on the other end to a smaller at the start of the processed region of the DCFD 314;

At a step 304, the DCFD 312 (or 314) was spliced to a conventional optical fiber 322, at the exposed end of the respective unprocessed region 316 (or 318), to produce, at a step 306, the desired optical fiber assembly 324 (or 326).

As was previously discussed, the purpose of the unprocessed region 316 and partially processed 318 (and optionally 320) was twofold: first to enable an otherwise fragile DCFD to be handled and to be spliced to a conventional fiber 322 without damaging the DCFD, and second to enable interfacing of the DCFD to a conventional optical fiber when the DCFD has different interface characteristics therefrom (such as being of a smaller diameter).

Because the required length of the unprocessed or partially processed region could be quite significant, at least a portion of each preform used for fabrication of DCFDs was essentially wasted, and the lengths of resulting optical fiber assemblies 324 (and 326) undesirably increased. The inventive process advantageously addresses these and other drawbacks of the process 300, and of other assembly fabrication processes in which DCFDs were fabricated separately prior to being spliced to conventional optical fibers.

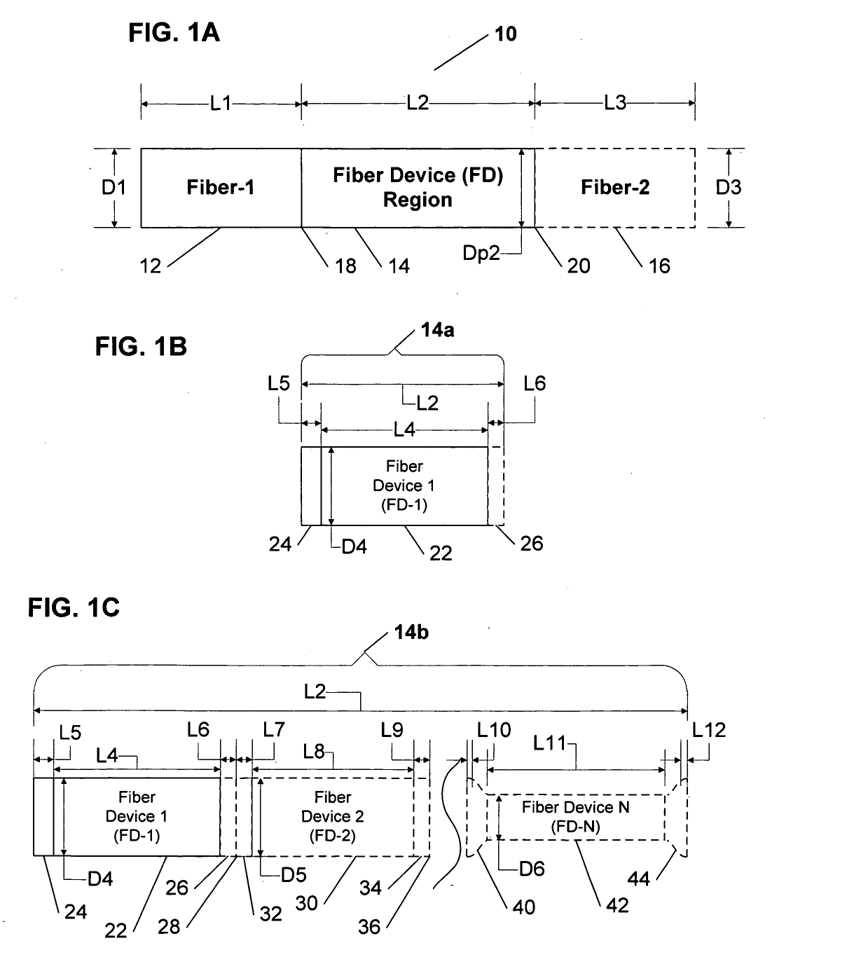

Referring now to FIG. 1A, the objective of the process of the present invention is to fabricate a desirable optical fiber assembly, a first embodiment of which is shown as an optical fiber assembly 10 (FIG. 1A). The assembly 10 includes at least two integral elements—a Fiber-1 12, of predetermined length L1 and diameter D1, which may be any conventional optical fiber, and a fiber device (“FD”) region 14 (of predetermined length L2 and diameter profile Dp2, which may include one or more fiber devices (being of a single or of different diameters). The fiber device(s) in the FD region 14 may include chiral fiber device(s), non-chiral fiber device(s), or a combination of both. Advantageously, the Fiber-1 12 portion of the assembly 10 may be utilized unchanged (or connectorized for certain applications) to easily install the assembly 10 in any desired optical fiber network, system or system component through any conventional connectorization or other fiber to fiber interface.

Optionally, for applications where the assembly 10 may be utilized as an in-fiber component, the assembly 10 may also include an additional integral element—a Fiber-2 16, of predetermined length L3 and diameter D3, integral with the end of the FD region 14, and positioned at the end of the FD region 14 opposite to the end integral with the Fiber-1 12. The additional element Fiber-2 16 may also be connectorized (as needed) to connect to the same type of optical fiber as Fiber-1 12, or configured to connect to a different type of optical fiber.

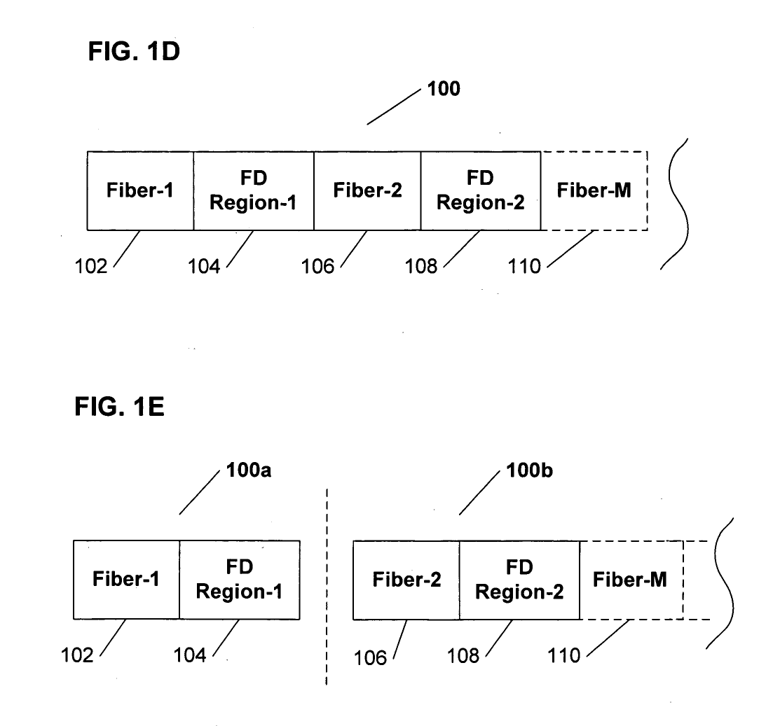

Referring now to FIG. 2, a preferred embodiment of the inventive process for fabricating one or more desired optical fiber assemblies is shown as a fabrication process 150. At a first step 152, optical fiber element(s) and fiber device preform element(s) are selected and sequentially positioned, in accordance with the desired optical fiber assembly characteristics and functionality. The selection of one or more optical fiber elements depends on the desired connectivity of the optical fiber assembly. For example, if the desired optical fiber assembly is to include chiral fiber Bragg grating functionality and connectivity to conventional optical fibers used in telecommunication applications, then at the step 152, an optical fiber element, with interface characteristics matched to such conventional optical fibers is selected. Optionally, if the desired assembly is to be connectable on both of its ends, a second optical fiber element may be similarly selected (and may be the same as, or different from, the first optical fiber element.

The selection of one or more fiber device preforms at the step 152, preferably depends on one or more of the following parameters: the desired functionality and characteristics of the one or more chiral fiber device element(s) of the desired optical fiber assembly (e.g., mode filter, polarizer, fiber bragg grating, etc.), the availability of various preform processing techniques, and the interface characteristics of one or two optical fiber elements to which the fiber device preform is to be connected. The preform selection approach is otherwise similar to the approach used in previously described individual chiral fiber device fabrication process.

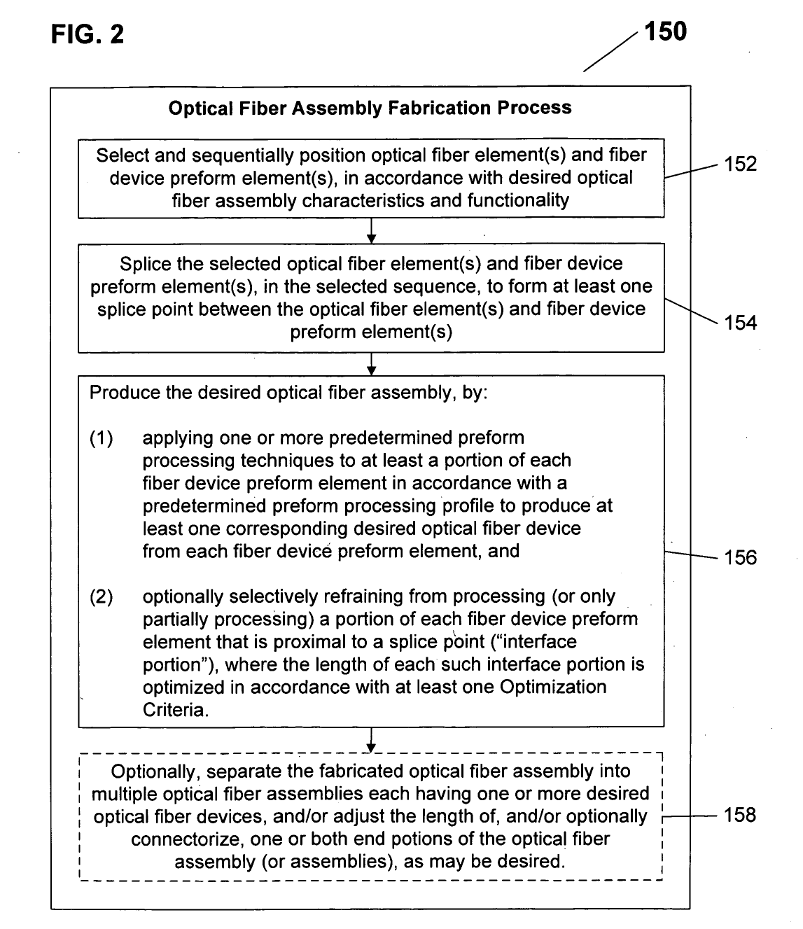

The quantity and sequential positions of each of the optical fiber and fiber device preform elements are also selected as a matter of design choice, in view of the desired optical fiber assembly functionality and characteristics. Referring now to FIG. 3A, an exemplary arrangement of optical fiber and fiber device preform elements 200a is shown, having at least an optical fiber element Fiber-1 202, and a sequentially positioned fiber device preform element (“FPE”)-1 204. Optionally, as noted above, if multiple optical fiber and/or fiber device preform elements are selected at the step 152, the arrangement 200a may also include sequentially positioned Fiber-2 206, FPE-2 208, Fiber-M 210, and so on.

Returning now to FIG. 2, at a step 154, the optical fiber and fiber device preform elements selected and positioned at said step 152, are spliced at one or more splice points (i.e., where an end of one element is proximal to an end of another element), to produce an optical fiber pre-assembly. Any conventional technique capable of splicing optical fiber elements and preforms may be readily used for the splicing process at the step 154. Referring now to FIG. 3B, an exemplary optical fiber pre-assembly 200b is shown, with the elements 202 and 204 being spliced at a Splice Point A (and optionally, with optional elements 206 to 210, being spliced at Splice Points B to D).

At a step 156, the desired optical fiber assembly is produced from the optical fiber pre-assembly, by applying one or more predetermined preform processing techniques to at least a portion of each optical fiber device preform element, in accordance with a predetermined preform processing profile, to produce at least one corresponding desired optical fiber component from each optical fiber device preform element present in the pre-assembly, while selectively refraining from processing (or only partially processing) a portion of each optical fiber device preform element that is proximal to a splice point (hereinafter “interface portion”), where the length of each such interface portion is optimized in accordance with at least one optimization criteria.

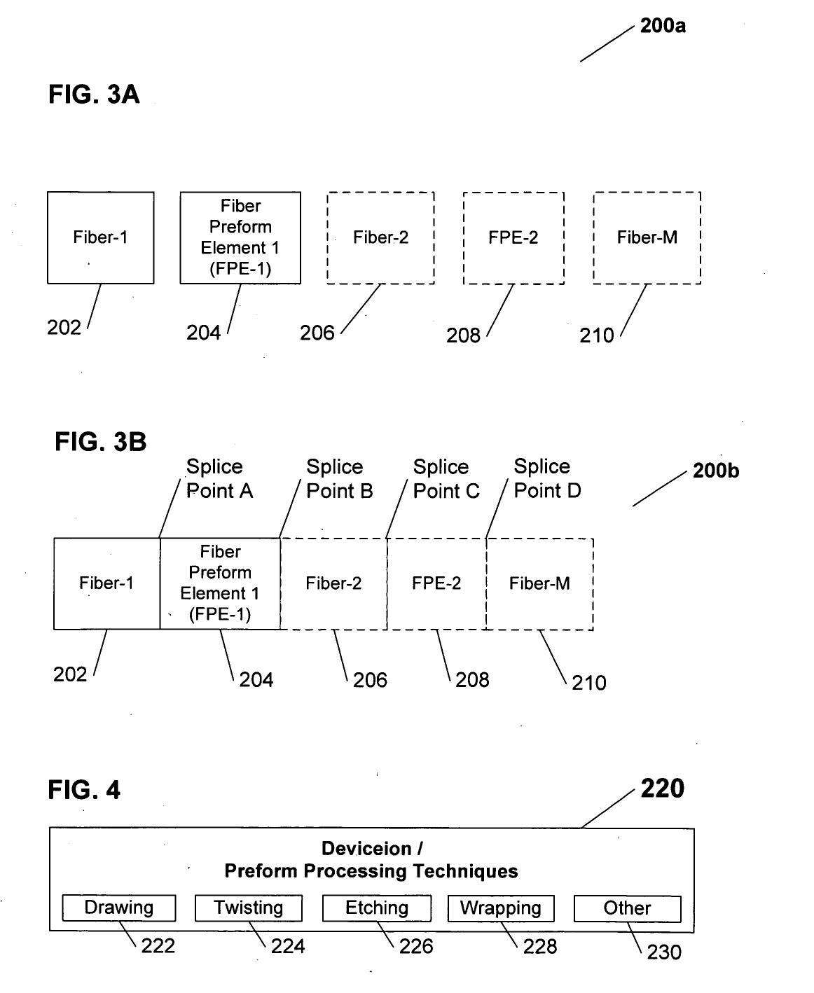

The various preform processing techniques utilized at the step 156 may include, but are not limited to, the preform processing techniques disclosed in the above-incorporated commonly assigned co-pending U.S. patent applications, or may include any other preform processing techniques that are capable of producing chiral or other types of fiber devices from corresponding selected preforms. Referring now to FIG. 4, a selection 220 of exemplary preform processing techniques that may be utilized individually, or in combination of two or more, for each fiber device preform element at the step 156, are shown as drawing 222, twisting 224, etching 226, wrapping 228, and other techniques 230. The techniques 222 to 228 are all discussed in greater detail in the above-incorporated commonly assigned co-pending U.S. patent applications.

The specific preform processing profile utilized for each fiber device preform element, is preferably determined based on the desired corresponding FD that is to be produced from the fiber device preform, and may include, but is not limited to, one or more of the following parameters: the quantity and type of each preform processing technique used, the duration of application of each preform processing technique, when two or more techniques are utilized, the relative timing and sequence of their application (e.g., simultaneous, overlapping, sequential, etc.), and at least one technique-specific processing parameter for each preform processing technique (e.g., for twisting—the speed and acceleration, for drawing—the temperature and desired product diameter, etc.).

Each interface region of each fiber device preform that is proximal to a splice point is preferably left unprocessed, or only partially processed. Partial processing, such as tapering, is useful in embodiments of the inventive process where at least one desired chiral fiber device is of a different physical configuration (e.g., diameter, etc.) than at least one of the optical fiber elements with which it is integral. However, even in such cases, preferably at least a small portion of the preform proximal to a splice point is left completely unprocessed. Nevertheless, in an alternate embodiment of the invention, when utilizing certain preform processing techniques, such as twisting, it may be useful to process the device preform up to the splice point without leaving an unprocessed area. This approach can be utilized in cases of different fiber element temperatures to produce a sharp transition in the helical pitch of the resulting fiber device.

In accordance with the present invention, the length of each interface region is optimized in accordance with one or more optimization criteria, and in certain cases can be substantially equal to zero. The optimization criteria may be based on one or more of the following: the intended application(s) of the desired optical fiber assembly, a selected balance between the strength of a splice point and the minimization of the length of the corresponding interface region, characteristics of the specific optical fiber elements, fiber device preforms selected at the step 152, the specific splicing technique(s) utilized at the step 154, and the specific preform processing techniques utilized at the step 156.

Accordingly, at the step 156, the desired optical fiber assembly is produced that includes the functionality of one or more FDs, and that may be readily utilized in any intended application.

To illustrate the results of the steps 152 to 156 of the process 150, it would be helpful to refer to FIGS. 1A to 1C, which show an exemplary embodiment of the desired optical fiber assembly 10, and various embodiments of its FD region 14. As noted above, the assembly 10 includes the optical fiber element Fiber-1 12 and the FD region 14 (having one or more FDs and one or two interface regions therein), with a splice point 18 therebetween (i.e., the point at which the Fiber-1 12, and a fiber device preform from which the proximal FD, of the FD region 14, was formed, were spliced at the step 154 of the process 150 of FIG. 2). If the optional element Fiber-2 16 is present, the assembly further includes a second splice point 20 between the Fiber-2 16 and the FD region 14. The length L1 (and L3) may be selected as a matter of design choice depending on the intended application(s) of the assembly 10.

As previously described, the FD region 14 may include a single FD (such as a chiral fiber device), as shown by way of example in FIG. 1B, or multiple sequential FDs (as shown by way of example in FIG. 1C), as a matter of design choice. In FIG. 1B, a first embodiment of the FD region 14 is shown, by way of example, as a FD region 14a of the length L2, which includes a single FD-1 22 of predetermined length L4 and diameter D4, and an interface region 24 of a predetermined length L5, between the splice point 18 and the FD-1 22. If the assembly 10 includes the optional element Fiber-2 16, the FD region 14a also includes a second interface region 26 of length L6, between the FD-1 22 and the splice point 20. Thus, the FD-1 22 represents the portion of a corresponding fiber device preform to which one or more preform processing techniques were applied at the step 156 of the process 150, and the interface region 24 (and optionally 26) represent the unprocessed (or partially processed) portion of the corresponding fiber device preform.

In accordance with the step 156 of the process 150, the length L5 (and L6) is preferably optimized in accordance with at least one optimization criteria. Advantageously, because the length L4 may be kept to a minimum necessary for the desired FD-1 22, with optimization of the length L5 (and L6), the overall length L2 of the FD region 14a is likewise optimized.

Referring now to FIG. 1C, a second embodiment of the FD region 14 is shown, by way of example, as a FD region 14b of the length L2, which includes multiple FDs and a corresponding interface region 24 proximal to the spice point 18 (and optionally an interface region 44 proximal to the splice point 20), as well as optional interface regions proximal to optional splice points between the FDs. Thus, by way of example, the FD region 14b may include the FD-1 22 of predetermined length L4 and diameter D4, a FD-2 30 of predetermined length L8 and diameter D5, through a FD-N 42 of predetermined length L11 and diameter D6.

The FD region 14b may also include an optional splice point 28 between the FD-1 22 and the FD-2 30, and an optional splice point 36 between the FD-2 30 and the FD-N 42. The splice points 28 and 36 are optional because in one embodiment of the present invention, it is possible to form multiple different sequential FDs by varying the preform processing profile at the step 156 over selected sequential regions of a single fiber device preform element. However, if multiple fiber device preforms were selected at the step 152, and then spliced at the step 154, the FD region 14b also includes corresponding interface regions 26, 32 proximal to the splice point 28, and interface regions 34, 40 proximal to the splice point 36. By way of example, because the diameter D6 of the FD-N 42 is smaller than diameter D5 of the proximal FD-2 30 (and smaller that the diameter D3 of the optional element Fiber-2 16), the corresponding optional interface regions 40 and 44 are partially processed (for example, tapered) to provide a suitable interface and transition to the connected elements, but each also include a corresponding unprocessed portion of lengths L10 and L12, proximal to the respective optional splice points 36 and 20.

In accordance with the step 156 of the process 150, the length L5, and lengths L6, L7, L9, L10, and L12 (if the corresponding interface regions are present) are preferably optimized in accordance with the at least one optimization criteria. Advantageously, because the lengths L4, L6, and L11 may be kept to a minimum necessary for the desired corresponding FD, with optimization of the length L5 (and lengths L6, L7, L9, L10, and L12, if present), the overall length L2 of the FD region 14b is likewise optimized.

Referring now to FIG. 2, in an alternate embodiment of the process 150 of the present invention, multiple optical fiber assemblies can be readily and easily fabricated in a continuous process, by forming, at the steps 152 and 154, a single elongated pre-assembly from multiple selected optical fiber elements and fiber device preforms in a desired sequential order, and applying one or more preform processing techniques at the step 156 to a portion of each fiber device preform to produce a multi-assembly comprising multiple integral sequential optical fiber assemblies, such an exemplary multi-assembly 100 (shown in FIG. 1D) that includes optical fiber elements Fiber-1 102, Fiber-2 106, and Fiber-M 110, as well as FD region-1 104 and FD region-2 108.

At an optional step 158 of the process 150, the fabricated optical fiber multi-assembly is separated into multiple optical fiber assemblies each having one or more optical desired fiber devices, as shown, by way of example, in FIG. 1E where the multi-assembly 100 is separated into two different optical fiber assemblies 100a and 100b. It should also be noted that the separation into multiple assemblies does not have to occur at a splice point, but can also occur by cutting through any appropriate optical fiber element(s) of the assembly. Optionally or alternately, at the step 158, the length of each optical fiber element at one end or at both ends of the fabricated optical fiber assembly may be adjusted as necessary, and/or one or both of the ends of the optical fiber assembly may be connectorized.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A method for fabricating a optical fiber assembly having predetermined desired functionality and characteristics, the optical fiber assembly comprising at least one optical fiber element integral with at least one desired optical fiber device element, the method comprising the steps of:
(a) providing at least one fiber device preform element, each selected to enable production of at least one corresponding desired optical fiber device therefrom;
(b) splicing, at least one splice point, the at least one optical fiber element to said at least one fiber device preform element, in a first predetermined sequence, to form an optical fiber pre-assembly; and
(c) selectively applying at least one preform processing technique to a portion of each said at least one fiber device preform element, to produce at least one processed region, each comprising a corresponding at least one optical fiber device, and at least one interface region, proximal to each of said at least one splice points, wherein a length of each said at least one interface region is optimized in accordance with at least one optimization criteria, to produce the optical fiber assembly having the predetermined desired functionality and characteristics.

2. The method of claim 1, wherein each of the at least one optical fiber elements, comprises a first set of corresponding interface characteristics, wherein each said at least one fiber device preform element comprises a second set of interface characteristics, wherein said step (a) further comprises the step of:
(d) selecting each said at least one fiber device preform to substantially match said corresponding second set of interface characteristics to at least one of the first sets of interface characteristics to facilitate splicing therebetween at said step (b).

3. The method of claim 1, wherein each said at least one preform processing technique of said step (c), is selected from a group of: preform drawing, preform twisting, preform etching, and preform wrapping.

4. The method of claim 1, wherein each said at least one preform processing technique comprises a plurality of preform processing techniques, and wherein said step (c) further comprises the step of:
(e) applying each said plural preform processing technique to each said at least one fiber device preform, at a predetermined sequence, for a predetermined duration, and with at least one predetermined parameter, to produce each said at least one corresponding desired optical fiber device element therefrom.

5. The method of claim 1, wherein when said at least one processed region comprises substantially different characteristics from the at least one optical fiber element, said step (c) further comprises the step of:
(f) applying at least a portion of said at least one preform processing techniques to at least one selected interface region of said at least one fiber device preform to minimize insertion loss for light traveling between the at least one optical fiber element and said at least one optical fiber device.

6. The method of claim 1, wherein each said optimization criteria comprise the step of:
(g) selectively balancing minimization of length of each said at least one interface region against a strength of said corresponding proximal splice point.

7. The method of claim 1, wherein each said at least one fiber device preform element is selected and configured for production of a chiral fiber device therefrom, and wherein each corresponding said at least one optical fiber device produced at said step (c) is a chiral fiber device.

8. The method of claim 1, wherein said at least one optical fiber device is selected from a group of: polarizer, sensor, mode filter, fiber bragg grating, long period grating, laser, spectral filter, and coupler.

9. The method of claim 1, wherein said at least one fiber device preform comprises a plurality of sequential fiber device preforms, each selected and positioned to enable production of a corresponding desired optical fiber device therefrom, and wherein said step (c) comprises the step of:
(h) applying said at least one preform processing technique to each plural preform to produce a corresponding optical fiber device therefrom.

10. The method of claim 1, wherein each said at least one fiber device preform is selected to enable fabrication of a chiral structure therefrom, and wherein said at least one preform processing technique utilized at said step (c) is selected to produce at least one corresponding chiral fiber device therefrom.

11. The method of claim 1, wherein said at least one optical fiber element comprises a plurality of optical fiber elements, wherein said at least one fiber device preform comprises a plurality of fiber device preforms, and wherein:
said step (b) comprises the step of:
(i) splicing, at a plurality of splice points, said plural optical fiber elements, to said plural fiber device preforms in a second predetermined sequence, to form a plurality of sequential optical fiber pre-assemblies;
the method further comprising the steps of:
(j) performing said step (c) for each plural optical fiber pre-assembly to produce a plurality of sequential optical fiber assemblies; and
(k) separating said plural optical fiber assemblies from one another.

12. The method of claim 1, further comprising the step of:
(l) connectorizing at least one optical fiber element having an unspliced end, for use in at least one predetermined application.

13. The method of claim 1, wherein said step (c) further comprises the step of:
(m) selecting said at least one optimization criteria that sets said length of said at least one interface region substantially at zero.
